(19) United States
(12) Patent Application Publication
(10) Pub. No.: US 2025/0062993 A1
(43) Pub. Date: Feb. 20, 2025

(54) ENERGY MANAGEMENT SYSTEM

(71) Applicant: ZHEJIANG JINKO ENERGY STORAGE CO., LTD., Haining (CN)

(72) Inventor: Pengfei ZANG, Haining (CN)

(21) Appl. No.: 18/937,422

(22) Filed: Nov. 5, 2024

(30) Foreign Application Priority Data
Jun. 26, 2024 (CN) 202410841214.5
Jun. 26, 2024 (CN) 202410843503.9

(51) Int. Cl. H04L 47/125; H04L 43/0882; H04L 45/24; H04L 47/2416

(52) U.S. Cl. CPC H04L 47/125; H04L 43/0882; H04L 45/24; H04L 47/2416

(57) ABSTRACT

An energy management system includes a data acquisition layer, a data storage layer, and a data management layer. The data acquisition layer is configured to obtain and analyze original data of one or more access devices to obtain analyzed data, and each access device is a device of an energy storage system. The data storage layer is configured to store the analyzed data outputted by the data acquisition layer. The data management layer is configured to send the analyzed data stored in the data storage layer to a client server or a third-party server according to a sending request or configuration information. The data acquisition layer includes a first communication device configured to establish a first communication link and a second communication link with each access device, and includes a first load balancing device configured to control a communication status of the first communication device.

### CROSS-REFERENCE TO RELATED APPLICATION

The present application claims the priority of Chinese patent application No. 202410843503.9, filed on Jun. 26, 2024, and entitled “ENERGY MANAGEMENT SYSTEM FOR STORING ENERGY, ENERGY MANAGEMENT METHOD, AND ENERGY STORAGE CABINET”, and Chinese patent application No. 202410841214.5, filed on Jun. 26, 2024, and entitled “ENERGY MANAGEMENT SYSTEM, ENERGY MANAGEMENT METHOD, AND ENERGY STORAGE CABINET”, which are incorporated herein by reference in their entireties.

### TECHNICAL FIELD

The present disclosure relates to the field of energy management technology, and in particular to an energy management system.

### BACKGROUND

In an existing energy management system, data collection is usually carried out by directly sending data to an application party after being accessed through the network. In this way, problems of network congestion and information loss may occur in the case of too many data collection points and an unstable network.

### SUMMARY

In the first aspect, the present disclosure provides an energy management system, including a data acquisition layer, a data storage layer, and a data management layer.

The data acquisition layer is configured to obtain and analyze original data of one or more access devices to obtain analyzed data, and each access device is a device of an energy storage system.

The data storage layer is configured to store the analyzed data outputted by the data acquisition layer.

The data management layer is configured to send the analyzed data stored in the data storage layer to a client server or a third-party server according to a sending request or configuration information.

The data acquisition layer comprises a first communication device and a first load balancing device.

The first communication device is configured to establish a first communication link and a second communication link with each access device.

The first load balancing device is configured to control a communication status of the first communication device, so that each access device communicates with the first communication device through the first communication link in a case that a communication flow of the first communication device is less than a first threshold value, and so that each access device communicates with the first communication device through both the first communication link and the second communication link in a case that the communication flow of the first communication device is greater than or equal to the first threshold value.

In one of the embodiments, the first load balancing device comprises an information acquisition unit, a packet capture unit, a first comparison unit, and a control unit.

In a case that each access device communicates through the first communication link alone:
the information acquisition unit is configured to obtain first configuration information of the first communication link;
the packet capture unit is configured to capture a data packet comprising the first configuration information within a preset time period to obtain a first real-time network data packet;
the first comparison unit is configured to compare the first real-time network data packet with the first threshold value;
the control unit is configured to, in a case that the first real-time network data packet is greater than or equal to the first threshold value for a preset number of consecutive times, control the second communication link to start, and control the first communication device to communicate through the first communication link and the second communication link.

In one of the embodiments, the first load balancing device comprises an information acquisition unit, a packet capture unit, a first comparison unit, and a control unit.

In a case that the first communication link and the second communication link are used for communication together:
the information acquisition unit is configured to acquire first configuration information of the first communication link and second configuration information of the second communication link;
the packet capture unit is configured to capture a data packet comprising the first configuration information within a preset time period, and a data packet comprising the second configuration information within the preset time period, to obtain a first real-time network data packet and a second real-time network data packet;
the first comparison unit is configured to compare a sum of the first real-time network data packet and the second real-time network data packet with the first threshold value; and
the control unit is configured to, in a case that the sum of the first real-time network data packet and the second real-time network data packet is less than the first threshold value for a preset number of consecutive times, control the second communication link to be cut off, and switch the first communication device to be in communication with each access device through the first communication link.

In one of the embodiments, the first load balancing device is further configured to control the first communication device to communicate through the first communication link and the second communication link during a set time period, and the set time period is a peak communication time period.

In one of the embodiments, the data management layer comprises a forwarding device. The forwarding device comprises: a second communication device and a second load balancing device.

The second communication device is configured to establish a third communication link and a fourth communication link with the client server or the third-party server.

The second load balancing device configured to: control a working status of the second communication device; control each access device to communicate through the third communication link when a communication flow of the second communication device is less than a second threshold value; and control the third communication link and the fourth communication link to be used for communication together when the communication flow of the second communication device is greater than or equal to the second threshold value.

In one of the embodiments, the data acquisition layer further comprises a data analyzing device, and the data analyzing device comprises: an analyzing unit, a second comparison unit and a writing unit.

The analyzing unit is configured to analyze the original data to obtain the analyzed data.

The second comparison unit is configured to compare the analyzed data with previous analyzed data obtained through analyzing last time to determine whether the analyzed data have changed or not.

The writing unit is configured to write the analyzed data to the data storage layer.

The data storage layer comprises a first storage area and a second storage area.

The first storage area is configured to store the data analyzed by the data acquisition layer each time.

The second storage area is configured to store the analyzed data which, compared with the previous analyzed data, have changed.

In one of the embodiments, the second storage area comprises a changed-status-data storage area and a changed-analog-data storage area.

The changed-status-data storage area is configured to store the analyzed data, whose working status data, compared with those of the previous analyzed data, have changed; and

The changed-analog-data storage area is configured to store the analyzed data, whose analog data, compared with those of the previous analyzed data, have changed.

In one of the embodiments, each of the first storage area, the changed-status-data storage area, and the changed-analog-data storage area comprises multiple sub-storage areas respectively configured according to each access device connected to the data acquisition layer.

The data acquisition layer determines each sub-storage area corresponding to each access device according to data names and data values of the analyzed data, and writes the analyzed data to each sub-storage area corresponding to each access device.

In one of the embodiments, each sub-storage area of the first storage area comprises a plurality of data blocks arranged in a circular manner, and each sub-storage area of the first storage area, which is one-to-one correspondence with each access device, is configured to sequentially store analyzed data of a corresponding access device to the plurality of data blocks thereof according to write times.

In one of the embodiments, each sub-storage area of the changed-analog-data storage area comprises a plurality of data blocks arranged in a circular manner, and each data block is configured to store a changed analog data.

In one of the embodiments, the writing unit is configured to write the analyzed data to the data storage layer by using a locking path; the locking path is a path using a mutex lock; and the mutex lock is configured to realize a mutual exclusion of write operations.

In a second aspect, the present disclosure discloses an energy management method, applied to the energy management system above. The method includes following steps.

The original data of one or more access devices are obtained and analyzed to obtain the analyzed data, and each access device is the device of the energy storage system.

The analyzed data are stored.

Stored analyzed data are sent to the client server or the third-party server according to the sending request or the configuration information.

Obtaining and analyzing the original data of one or more access devices to obtain the analyzed data comprises following steps.

The first communication link and the second communication link are established between the first communication device and each access device.

The communication status of the first communication device is controlled, so that each access device communicates with the first communication device through the first communication link in a case that the communication flow of the first communication device is less than the first threshold value, and so that each access device communicates with the first communication device through both in the case that the communication flow of the first communication device is greater than or equal to the first threshold value.

In one of the embodiments, in a case that each access device communicates through the first communication link alone, controlling the communication status of the first communication device comprises following steps.

First configuration information of the first communication link is obtained.

A data packet comprising the first configuration information within a preset time period is captured to obtain a first real-time network data packet.

The first real-time network data packet is compared with the first threshold value.

In a case that the first real-time network data packet is greater than or equal to the first threshold value for a preset number of consecutive times, the second communication link is controlled to start, and the first communication link and the second communication link are controlled to be used for communication together.

In one of the embodiments, in a case that the first communication link and the second communication link are used for communication together, controlling the communication status of the first communication device comprises following steps.

First configuration information of the first communication link and second configuration information of the second communication link are acquired.

A data packet comprising the first configuration information within a preset time period and a data packet comprising the second configuration information within the preset time period are captured to obtain a first real-time network data packet and a second real-time network data packet.

A sum of the first real-time network data packet and the second real-time network data packet is compared with the first threshold value.

In a case that the sum of the first real-time network data packet and the second real-time network data packet is less than the first threshold value for a preset number of consecutive times, the second communication link is controlled to be cut off communication, and the first communication device is switched to be in communication with each access device through the first communication link alone.

In one of the embodiments, controlling the communication status of the first communication device comprises controlling the first communication device to communicate through the first communication link and the second communication link during a set time period, wherein the set time period is a peak communication time period. In one of the embodiments, the preset time period is 2 s, 3 s, or 5 s.

In one of the embodiments, sending the stored analyzed data to the client server or the third-party server according to the sending request or the configuration information comprises following steps.

A third communication link and a fourth communication link are established between a second communication device and the client server or the third-party server.

A working status of the second communication device is controlled. each access device is controlled to communicate through the third communication link when a communication flow of the second communication device is less than a second threshold value. The third communication link and the fourth communication link are controlled to be used for communication together when the communication flow of the second communication device is greater than or equal to the second threshold value.

In one of the embodiments, storing the analyzed data comprises following steps. The analyzed data are compared with previous analyzed data obtained through analyzing last time to determine whether the analyzed data have changed or not. The analyzed data obtained each time are written to a first storage area. The analyzed data which, compared with the previous analyzed data, have changed, are written to a second storage area.

In one of the embodiments, the second storage area comprises a changed-status-data storage area and a changed-analog-data storage area. Writing the analyzed data which, compared with the previous analyzed data, have changed, to the second storage area, comprises following steps.

The analyzed data whose working status data, compared with working status data of the previous analyzed data, have changed, are written to the changed-status-data storage area.

The analyzed data whose analog data, compared with analog data of the previous analyzed data, have changed, are written to the changed-analog-data storage area.

In one of the embodiments, writing the analyzed data to the first storage area or to the second storage area is performed by using a locking path. The locking path is a path using a mutex lock; and the mutex lock is configured to realize a mutual exclusion of write operations.

In a third aspect, the present disclosure discloses an energy storage cabinet, including a battery pack, an energy storage converter and the energy management system above.

In the energy management system, the energy management method and the energy storage cabinet of the present disclosure, the first load balancing device is arranged at the data acquisition layer to monitor the communication load of the first communication device, and switch the working status of the communication links of the first communication device according to the flow load of the first communication device, thereby balancing the communication load of the first communication device, and avoiding a network congestion, a packet loss and other problems caused by the excessive data volume.

### BRIEF DESCRIPTION OF THE DRAWINGS

In order to illustrate the technical solutions of the embodiments of the present disclosure more clearly, the drawings needed for the description of the embodiments are briefly described hereinafter. Obviously, the drawings described hereinafter are only some embodiments of the present disclosure. For the ordinary skilled in the art, other drawings may be obtained based on these drawings without creative work.

FIG. 1 is a block diagram showing a structure of an energy management system of an embodiment;

FIG. 2 is a block diagram showing a structure of a data acquisition layer of an embodiment;

FIG. 3 is a block diagram showing a structure of a first load balancing device of an embodiment;

FIG. 4 is a block diagram showing a structure of a data management layer of an embodiment;

FIG. 5 is a view showing a data storage layer of an embodiment;

FIG. 6 is a view showing a sub-storage area of a first storage area of an embodiment;

FIG. 7 is a block diagram showing a structure of a data analysis device of an embodiment;

FIG. 8 is a block diagram showing a structure of a forwarding device of an embodiment;

FIG. 9 is a flow chart of an energy management method of an embodiment;

FIG. 10 is a flow chart of obtaining and analyzing original data of an access device according to an embodiment;

FIG. 11 is a flow chart of writing analyzed data to a data storage layer of an embodiment;

FIG. 12 is a view showing an internal structure of an energy storage cabinet of an embodiment.

### DETAILED DESCRIPTION OF THE EMBODIMENTS

To facilitate understanding of the present disclosure, the present disclosure will be described in more detail hereinafter with reference to the relevant drawings. The preferred embodiments of the present disclosure are shown in the drawings. However, the present disclosure may be implemented in many different forms and is not limited to these embodiments described herein. On the contrary, the purpose of providing these embodiments is to make the disclosure of the present disclosure more thorough and comprehensive.

Unless otherwise defined, all technical and scientific terms used herein have the same meaning as those generally understood by the ordinary skilled in the art of the present disclosure. The terms used in the specification of the present disclosure herein are only for the purpose of describing specific embodiments and are not intended to limit the present disclosure.

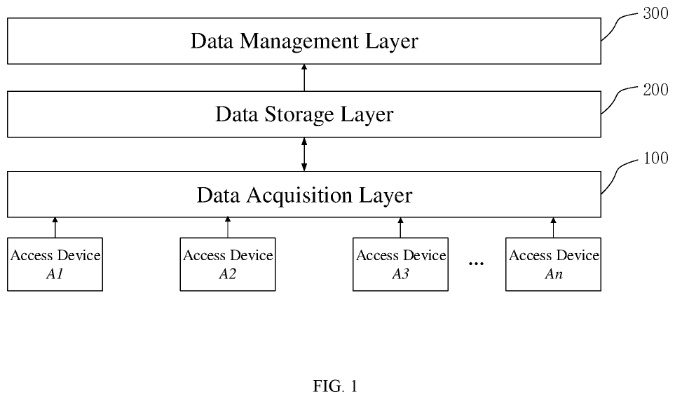

An exemplary embodiment of the present disclosure provides an energy management system. As shown in FIG. 1, the energy management system includes a data acquisition layer 100, a data storage layer 200, and a data management layer 300.

The data acquisition layer 100 is configured to obtain original data of an access device, analyze the original data, and obtain analyzed data. The access device is a device of an energy storage system. The data acquisition layer 100 is connected to multiple access devices A1-An of the energy storage system. For example, an access device An may be an electric meter, a transformer, a current transformer of the energy storage system, etc. The data acquisition layer 100 obtains original data of the multiple access devices A1-An, and the original data of the access devices A1-An include operation data, power data, test data, etc. For example, the original data obtained by the data acquisition layer 100 include parameters such as voltage, power, current, and working status of the access devices A1-An.

The data storage layer 200 is configured to store the analyzed data outputted by the data acquisition layer 100.

The data management layer 300 is configured to send the analyzed data stored in the data storage layer 200 to a client server or a third-party server according to a sending request or configuration information.

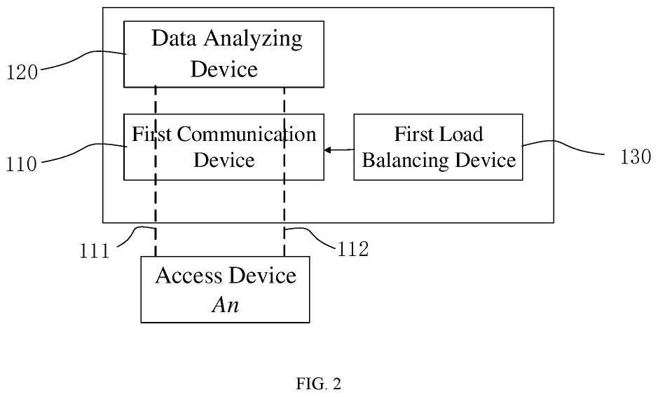

As shown in FIG. 2, the data acquisition layer 100 includes a first communication device 110 and a first load balancing device 130. The first load balancing device 130 is configured to control the working status of the first communication device 110 according to a flow load of the first communication device 110 to balance a communication load of the first communication device 110.

The first communication device 110 is configured to establish a first communication link 111 and a second communication link 112 with the access devices A1-An. The first communication link 111 is used as the main communication link to collect the original data of the access devices A1-An, and the second communication link 112 is used as a backup communication link to share the communication load of the first communication link 111 when the first communication link 111 is heavily loaded and the network is congested.

The first load balancing device 130 is configured to control the communication status of the first communication device 110, so that the access devices A1-An communicate with the first communication device 110 through the first communication link 111 when the communication flow of the first communication device 110 is less than a first threshold value, and so that the access devices A1-An communicate with the first communication device 110 through both the first communication link 111 and the second communication link 112 when the communication flow of the first communication device 110 is greater than or equal to the first threshold value. That is, when the communication flow of the first communication link 111 is greater than or equal to the first threshold value, the second communication link 112 is started. When the total communication flow of the first communication link 111 and of the second communication link 112 is less than the first threshold value, the second communication link 112 is cut off.

The first threshold value may be a set fixed value, or the first threshold value may be a variable value flexibly adjusted according to a network status or a time period.

In the energy management system of an embodiment, the first load balancing device 130 is provided in the data acquisition layer 100 to monitor the communication flow of the first communication device 110. If the data volume is too large and the network is congested, the backup second communication link 112 is started to share the data communication of the first communication link 111, thus balancing the communication load, and avoiding a network congestion, a packet loss and other problems caused by the excessive data volume. If the total communication flow of the first communication link 111 and the second communication link 112 is reduced to below the first threshold value, the second communication link 112 is cut off.

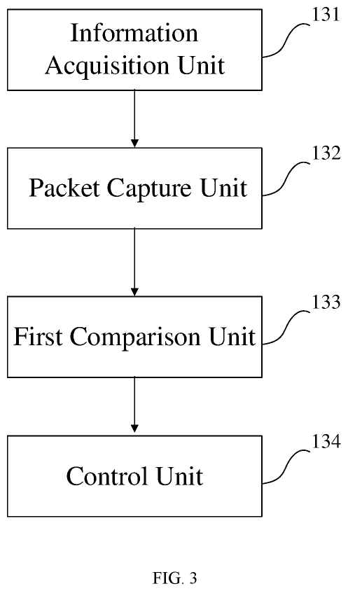

In some embodiments, referring to FIG. 3, the first load balancing device 130 includes an information acquisition unit 131, a packet capture unit 132, a first comparison unit 133 and a control unit 134.

When the access devices A1-An communicate through the first communication link 111 alone, the first load balancing device 130 is arranged as follows.

The information acquisition unit 131 is configured to obtain first configuration information of the first communication link 111. In an embodiment, the first configuration information may include an IP address and a communication port of the first communication link 111.

The packet capture unit 132 is configured to capture a data packet including the first configuration information within a preset time period, to obtain a first real-time network data packet. Specifically, the packet capture unit 132 captures a data packet including the first configuration information within the preset time period by using the first configuration information as a keyword, to obtain the first real-time network data packet. The preset time period is a set time period, which may be 2 s, 3 s, 5 s, or any other time period.

The first comparison unit 133 is configured to compare the first real-time network data packet with the first threshold value.

The control unit 134 is configured to, when the first real-time network data packet is greater than or equal to the first threshold value for a preset number of consecutive times, control the second communication link 112 to start, and control the first communication device 110 to communicate through the first communication link 111 and the second communication link 112. In an embodiment, the preset number of consecutive times is the set number of times, for example, it may be set to 3 times, or 5 times, etc.

The first comparison unit 133 compares the first real-time network data packet with the first threshold value for the preset number of consecutive times. If the comparison result is that the first real-time network data packet is greater than or equal to the first threshold value for the preset number of consecutive times, the control unit 134 controls the second communication link 112 to start, and transfers half of the data collection points of the first communication link 111 to the second communication link 112. The first communication link 111 and the second communication link 112 are used for communication together, thereby reducing the load of the first communication link 111, avoiding a network congestion of the first communication link 111, and avoiding a packet loss.

If the comparison result is that the first real-time network data packet is less than the first threshold value for the preset number of consecutive times, it is determined that the load of the first communication link 111 is normal, and the second communication link 112 remains in the cut-off status. The first communication link 111 communicates alone, and the first load balancing device 130 stops monitoring the load of the first communication link 111. After a stop of a period of time (for example, 30 minutes), the load of the first communication link 111 is monitored again.

If the comparison result is that, in the preset number of consecutive times, at least once the first real-time network data packet is less than the first threshold value, then it is necessary to continue to capture the first real-time network data packet and compare the first real-time network data packet with the first threshold value, until the first real-time network data packet is greater than or equal to the first threshold value for the preset number of consecutive times, or not to stop capturing the data packet of the first configuration information until the first real-time network data packet is less than the first threshold value for the multiple consecutive data collection cycles.

In some embodiments, after the control unit 134 controls the second communication link 112 to start, the first load balancing device 130 may stop monitoring the first communication device 110, and after a stop of a period of time, the first load balancing device 130 monitors the load of the first communication device 110 again to reduce the workload of the first load balancing device 130.

In some embodiments, when the first communication link 111 and the second communication link 112 are used for communication together, the first load balancing device 130 is arranged as follows.

The information acquisition unit 131 is configured to acquire the first configuration information of the first communication link 111 and second configuration information of the second communication link 112. In an embodiment, the first configuration information includes the IP address and the communication port of the first communication link 111, and the second configuration information includes an IP address and a communication port of the second communication link 112.

The packet capture unit 132 is configured to capture the data packet including the first configuration information within the preset time period, and a data packet including the second configuration information within a preset time period, to obtain the first real-time network data packet and a second real-time network data packet. In an embodiment, the preset time period is a set time period, and the preset time period may be 2 s, 3 s, 5 s, or any other time period.

The first comparison unit 133 is configured to compare the sum of the first real-time network data packet and the second real-time network data packet with the first threshold value.

The control unit 134 is configured to, when the sum of the first real-time network data packet and the second real-time network data packet is less than the first threshold value for the preset number of consecutive times, control the second communication link 112 to be cut off, and switch the first communication device 110 to be in communication with the access devices A1-An through the first communication link 111. The control unit 134 switches communications through both the second communication link 112 and the first communication link 111 to the communication through the first communication link 111 alone, and transfers all the data collection points of the second communication link 112 to the first communication link 111.

After the control unit 134 switches the communications through both the second communication link 112 and the first communication link 111 to the communication through the first communication link 111 alone, the first load balancing device 130 may stop monitoring the first communication device 110. After a stop of a period of time, the first load balancing device 130 monitors the communication load of the first communication device 110 again to reduce the workload of the first load balancing device 130.

When the sum of the first real-time network data packet and the second real-time network data packet is less than the first threshold value for the preset number of consecutive times, it is determined that the load is normal, and the second communication link 112 is controlled to be cut off, and the data collection points of the second communication link 112 are transferred to the first communication link 111, and the original data of the access devices A1-An are obtained through the first communication link 111. After cutting off the second communication link 112, the control unit 134 stops monitoring the loads of the first communication link 111 and the second communication link 112, and after a stop of a period of time (for example, 30 minutes), the load of the first communication link 111 is monitored and the first real-time network data packet is obtained again.

When at least once the sum of the first real-time network data packet and the second real-time network data packet is greater than or equal to the first threshold value, it is determined that there is an overload, and the capturing of the data packet of the first configuration information and the data packet of the second configuration information is stopped, and the status of communications through both the first communication link 111 and the second communication link 112 remains unchanged. After a stop of a period of time (for example, 30 minutes), the first load balancing device 130 monitors the load of the first communication device 110 again.

In some embodiments, the first load balancing device 130 is configured to monitor the flow load of the first communication device 110 at intervals of time, so as to monitor the network status of the first communication device 110 timely and reduce the workload of the first load balancing device 130. For example, the first load balancing device 130 may monitor the flow load of the first communication device 110 once every 0.5 hours, one hour, or any other time period.

In some embodiments, the first load balancing device 130 is also configured to control the first communication device 110 to communicate through the first communication link 111 and the second communication link 112 during a set time period, and the set time period is a peak communication time period, thus reducing the workload of the first load balancing device 130. The peak communication time period may be a time period obtained according to historical data communication.

In some embodiments, referring to FIG. 2, the data acquisition layer 100 also includes a data analyzing device 120, which is connected to the first communication device 110 for communication. The data analyzing device 120 receives the original data collected by the first communication device 110, and analyzes the original data to obtain analyzed data, where the data analyzing device 120 analyzes the original data based on the protocol. The data analyzing device 120 writes the analyzed data to the data storage layer 200.

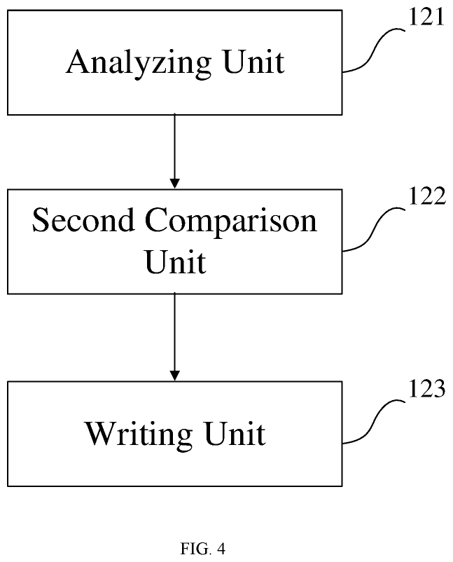

Referring to FIG. 4, the data analyzing device 120 includes an analyzing unit 121, a second comparison unit 122, and a writing unit 123.

The analyzing unit 121 is configured to analyze the original data to obtain the analyzed data.

The second comparison unit 122 is configured to compare the analyzed data with the previous analyzed data obtained through analyzing last time, to determine whether the analyzed data have changed or not.

The writing unit 123 is configured to write the analyzed data to the data storage layer 200.

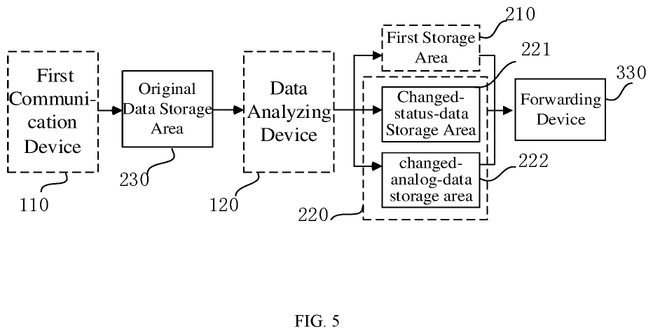

Referring to FIG. 5, the data storage layer 200 includes a first storage area 210 and a second storage area 220.

The first storage area 210 is configured to store the data analyzed by the data acquisition layer 100 each time.

The second storage area 220 is configured to store the analyzed data which, compared with the previous analyzed data, have changed.

Each time the data acquisition layer 100 obtains the original data of the access devices A1-An, the data analysis device 120 analyzes the original data to obtain the analyzed data, writes the analyzed data to the first storage area 210, and simultaneously, compares the analyzed data with the previous analyzed data of the access devices A1-An to determine whether the analyzed data of the access devices A1-An have changed or not. If the analyzed data of the access devices A1-An have changed, the analyzed data obtained by the analysis are written to the second storage area 220.

In some embodiments, referring to FIG. 5, the second storage area 220 includes a changed-status-data storage area 221 and a changed-analog-data storage area 222.

The changed-status-data storage area 221 is configured to store the analyzed data, whose working status data, compared with those of the previous analyzed data, have changed.

The changed-analog-data storage area 222 is configured to store the analyzed data, whose analog data, compared with those of the previous analyzed data, have changed.

The second comparison unit 122 compares the analyzed data of an access device An with the corresponding previous analyzed data. If the working status data of the analyzed data of the access device An have changed, the writing unit 123 writes the analyzed data to the changed-status-data storage area 221. If the analog data (the voltage, the power, or the current of the access device A1-An, etc.) of the analyzed data of the access device An have changed, the analyzed data are written to the changed-analog-data storage area 222. If both the working status data and the analog data of the analyzed data of the access device An have changed, the analyzed data are written to the changed-status-data storage area 221 and the changed-analog-data storage area 222 respectively. If neither the working status data nor the analog data have changed, the analyzed data are not written to the second storage area 220 in the current data collecting cycle.

For example, the analyzed data indicate that the working status of the access device An is “working”, and the previous analyzed data indicate that the working status of the access device An is “sleeping”, then the working status of the access device An has changed relatively. If the working status of the access device An is “working”, the changed working status data are written to the changed-status-data storage area 221. If the analyzed data obtained by a subsequent analyzing indicate that the working status of the access device An is “sleeping”, the changed subsequent working status data are written to the changed-status-data storage area 221, and the working status data previously stored in the changed-status-data storage area 221 are overwritten.

Similarly, if the analyzed data indicate that the current or power of the access device An has changed relative to the previous analyzed data, the analyzed data of the current or power of the access device An are written to the changed-analog-data storage area 222.

In some embodiments, each storage area includes a plurality of sub-storage areas corresponding to the respective access devices A1-An of the data acquisition layer 100.

The data acquisition layer 100 determines sub-storage areas corresponding to the access devices A1-An according to the data names and data values of the analyzed data, and writes the analyzed data to the sub-storage areas corresponding to the access devices A1-An.

For example, the first communication device 110 is connected to the device A1, the device A2, the device A3, . . . , and the device An for communication respectively, then each data storage area (each of the first storage area 210, the changed-status-data storage area 221, and the changed-analog-data storage area 222) is correspondingly provided with a sub-storage area M1, a sub-storage area M2, a sub-storage area M3, . . . , and a sub-storage area Mn.

The data acquisition layer 100 collects the original data of the access devices A1-An, and the communication configuration information of the access devices A1-An may be used as the identification of the original data, and the original data are named with the communication configuration information of the access devices A1-An. After the data acquisition layer 100 analyzes the original data and obtains the analyzed data, the analyzed data are written to the sub-storage area corresponding to the access devices A1-An in the first storage area 210 or in the second storage area 220 according to the data names and the data values of the analyzed data.

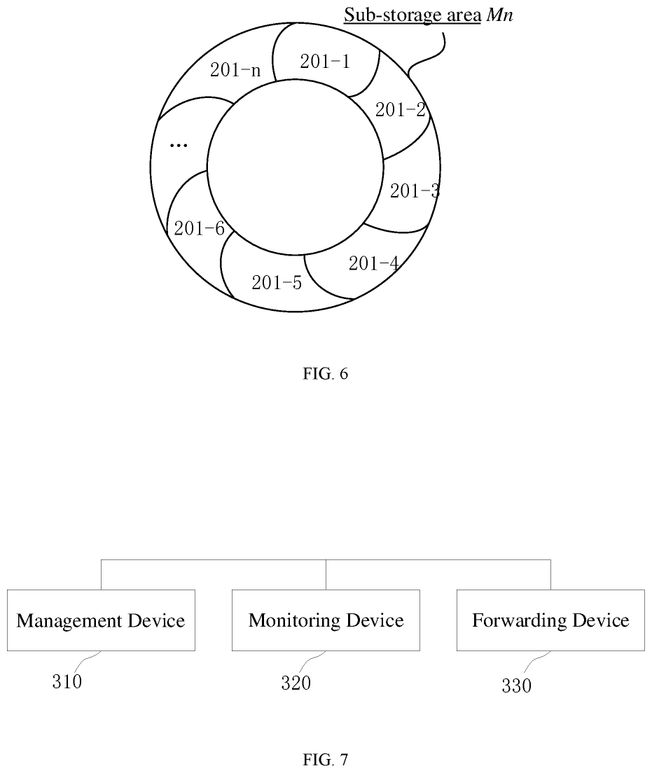

In some embodiments, referring to FIG. 6, each sub-storage area Mn of the first storage area 210 includes a plurality of data blocks 201-1 to 201-n arranged in a circular manner, and each sub-storage area Mn of the first storage area 210 is configured to sequentially store the analyzed data to the plurality of data blocks according to write times.

Each sub-storage area Mn of the first storage area 210 includes a plurality of data blocks 201-1 to 201-n arranged in a circular manner, and each data block is configured to store an analyzed data. A data block for storing firstly may be configured to be any one of the plurality of data blocks 201-1 to 201-n, and the analyzed data are written to the data blocks 201-1 to 201-n according to an order of the write times. If the data blocks 201-1 to 201-n in the sub-storage area are all full, then new analyzed data are written to the data blocks 201-1 to 201-n in the order of the writing times to overwrite the analyzed data stored in the data blocks, thus avoiding abnormal cases, such as the sub-storage area being full and a data overflow.

In an implementable embodiment, if the data blocks 201-1 to 201-n of a sub-storage area of the first storage area 210 are all full, and when new analyzed data are being written to a data block where an analyzed data is stored, the analyzed data stored in the data block may be deleted and then the new analyzed data is stored in the data block; or, the analyzed data stored in the data block may be replaced with the new analyzed data.

In some embodiments, each sub-storage area of the changed-analog-data storage area 222 includes a plurality of data blocks arranged in a circular manner, and each data block is configured to store a changed analog parameter.

For example, a sub-storage area of the changed-analog-data storage area 222 is configured to store the changed data of the analog parameters of the access device A1. The analog parameters of the access device A1 include a voltage, a power, and a current. The sub-storage area includes three data blocks, which are arranged in a circular manner. The three data blocks are configured to store the changed voltage parameter, the changed power parameter, and the changed current parameter of the access device A1 in sequence.

In some embodiments, multiple storage areas of the changed-status-data storage area 221 are arranged in a circular manner, and each sub-storage area is configured to store a changed status parameter of the access device An.

In some embodiments, the writing unit 123 writes the analyzed data to the data storage layer 200 by using a locking path, where the locking path is a path using a mutex lock, and the mutex lock is configured to realize a mutual exclusion of write operations.

In some embodiments, referring to FIG. 5, the data storage layer 200 also includes an original data storage area 230.

The original data storage area 230 is configured to store the original data obtained by the communication device.

The first communication device 110 obtains the original data of the access device A1-An, and packages the original data by using the communication configuration information of the original data as the identification, and writes the packaged original data to the original data storage area 230.

The data analyzing device 120 determines the original data to be analyzed according to the identification, and the analyzing unit 121 obtains the original data to be analyzed from the original data storage area 230, and analyzes the original data to obtain the analyzed data, thereby preventing the first communication device 110 from collecting too many data, preventing the data packets from being interfered with each other to affect the identification and transmission performed by the data analyzing device 120, and avoiding the problems of data losses or transmission errors during the analyzing process.

In some implementable embodiments, after the first communication device 110 obtains the original data, the first communication device 110 writes the original data to the original data storage area 230 by using the communication configuration information of the original data as the identification of the original data, where the communication configuration information of the original data (i.e., the configuration information of the first communication link 111 or the second communication link 112 for transmitting the original data) includes an IP address and a port of the communication link for transmitting the original data.

Based on the identification of the original data, the data analyzing device 120 names the analyzed data obtained through analysis, and writes the analyzed data to the data storage layer 200 according to the data names and data values of the analyzed data, so that the analyzed data of the same access device obtained by the first communication link 111 and by the second communication link 112 are all written to the sub-storage area corresponding to the access device, thereby avoiding an omission of data or a miswriting of data in the data storage layer 200.

In some embodiments, referring to FIG. 7, the data management layer 300 includes a management device 310, a monitoring device 320 and a forwarding device 330. The management device 310 is configured to initialize programs of each device and manage a start and a stop of each device. The monitoring device 320 is configured to monitor the program status of each device, and restart a communication program of a device if the program of the device is abnormally interrupted. The forwarding device 330 is configured to send the analyzed data stored in the data storage layer to a client server or a third-party server according to a sending request or configuration information.

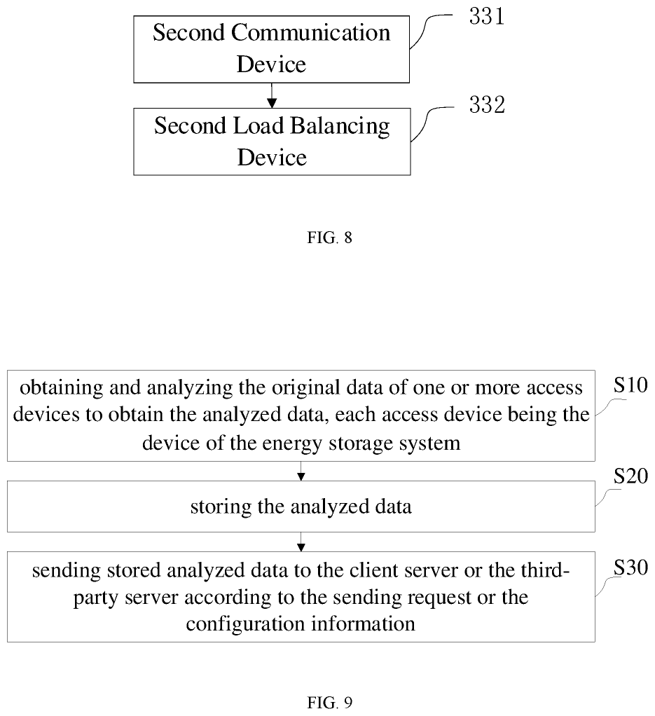

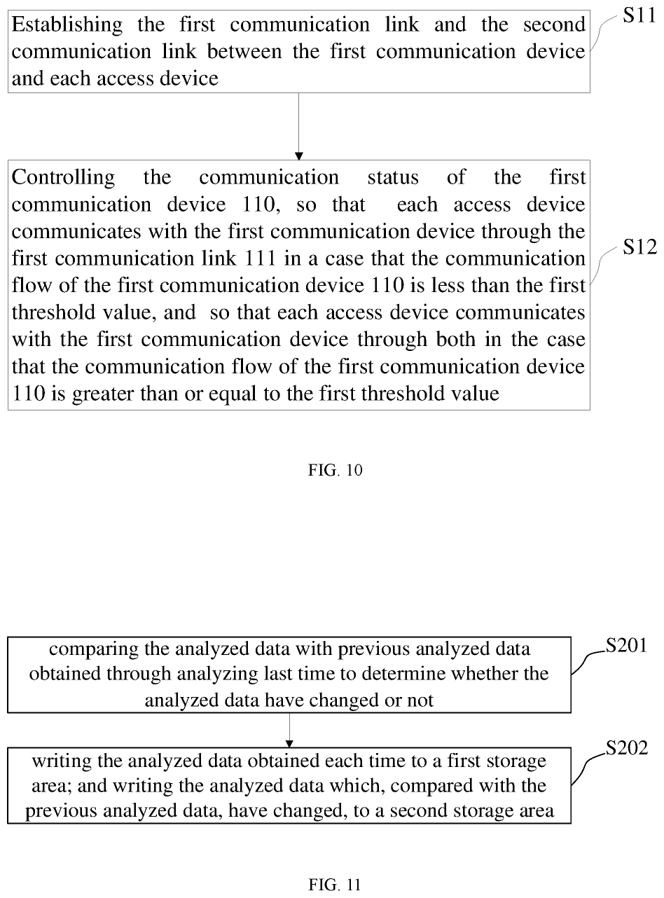

In some embodiments, as shown in FIG. 8, the forwarding device 330 includes a second communication device 331 and a second load balancing device 332.

The second communication device 331 is configured to establish a third communication link and a fourth communication link with a client server or a third-party server.

The second load balancing device 332 is configured to control a working status of the second communication device 331. When the communication flow of the second communication device 331 is less than a second threshold value, the access devices A1-An are controlled to communicate through the third communication link. When the communication flow of the second communication device 331 is greater than or equal to the second threshold value, the third communication link and the fourth communication link are controlled to be used for communication together.

An exemplary embodiment of the present disclosure provides an energy management method, which may be applied to an application environment of information collection of the access devices A1-An. The method may be used in the energy management systems above, and may also be applied to a terminal or a server, and may also be applied to a system including the terminal and the server and is implemented through an interaction between the terminal and the server. The terminal may be but is not limited to any one of personal computers, laptops, smart phones, tablet computers, etc.

In an embodiment, an energy management method is provided, and the method is described by taking the method applied to a terminal as an example. As shown in FIG. 9, the energy management method includes the following steps S10 to S30.

In Step S10, original data of an access device are obtained, and analyzed to obtain the analyzed data. The access device is a device of the energy storage system.

In Step S20, the analyzed data are stored.

The access device is a device of an energy storage system. Multiple access devices A1-An of the energy storage system are connected. For example, an access device An may be an electric meter, a transformer, a current transformer of the energy storage system, etc. Original data of the multiple access devices A1-An are obtained, and the original data of the access devices A1-An include operation data, power data, test data, etc. For example, the obtained original data include parameters such as voltage, power, current, and working status of the access devices A1-An.

In Step S30, the analyzed data stored in the data storage layer 200 are sent to a client server or a third-party server according to a sending request or configuration information.

Step S10 of obtaining and analyzing the original data of the access device to obtain the analyzed data includes steps S11 and S12.

In Step S11, a first communication link 111 and a second communication link 112 are established between the first communication device 110 and the access devices A1-An. In an embodiment, the first communication link 111 is used as the main communication link to collect the original data of the access devices A1-An, and the second communication link 112 is used as a backup communication link to share the communication load of the first communication link 111 when the first communication link 111 is heavily loaded and the network is congested.

In Step S12, the communication status of the first communication device 110 is controlled, so that the access devices A1-An communicate with the first communication device 110 through the first communication link 111 when the communication flow of the first communication device 110 is less than a first threshold value, and so that the access devices A1-An communicate with the first communication device 110 through both the first communication link 111 and the second communication link 112 when the communication flow of the first communication device 110 is greater than or equal to the first threshold value.

That is, when the communication flow of the first communication link 111 is greater than or equal to the first threshold value, the second communication link 112 is started. When the total communication flow of the first communication link 111 and the second communication link 112 is less than the first threshold value, the second communication link 112 is cut off. The first threshold value may be a set fixed value, or the first threshold value may be a variable value flexibly adjusted according to a network status or a time period.

In this embodiment, the terminal monitors the flow load of the collected original data, switches the communication status of the communication links according to the flow load of the collected original data, controls the first communication link 111 to be used for communication alone, or controls the first communication link 111 and the second communication link 112 to be used for communication together to balance the load of the communication link. The specific solution for balancing the communication links will be described in detail hereinafter.

In some embodiments, when the access devices A1-An communicate through the first communication link 111 alone, step S12 of controlling the communication status of the first communication device 110 includes Step S121 to Step 124.

In Step S121, first configuration information of the first communication link 111 is obtained. In an embodiment, the first configuration information may include an IP address and a communication port of the first communication link 111.

In Step S122: a data packet including the first configuration information within a preset time period is captured, to obtain a first real-time network data packet. In an embodiment, a data packet including the first configuration information within the preset time period is captured by using the first configuration information as a keyword, to obtain the first real-time network data packet. The preset time period is a set time period, which may be 2 s, 3 s, 5 s, or any other time period.

In Step S123, the first real-time network data packet is compared with the first threshold value.

In Step S124, when the first real-time network data packet is greater than or equal to the first threshold value for the preset number of consecutive times, the second communication link 112 is controlled to start, and the first communication link 111 and the second communication link 112 are controlled to be used for communication together.

The preset number of consecutive times is the set number of times, for example, it may be set to 3 times, or 5 times, etc. The first real-time network data packet is compared with the first threshold value for the preset number of consecutive times. If the comparison result is that the first real-time network data packet is greater than or equal to the first threshold value for the preset number of consecutive times, the second communication link 112 is controlled to start, and half of the data collection points of the first communication link 111 is transferred to the second communication link 112. The first communication link 111 and the second communication link 112 are used for communication together, thereby reducing the load of the first communication link 111, avoiding a network congestion of the first communication link 111, and avoiding a packet loss.

In some embodiments, if the first real-time network data packet is greater than or equal to the first threshold value for the preset number of consecutive times, the second communication link 112 is controlled to start, and the monitoring of the communication load may be stopped, and after a stop of a period of time, the communication load may be monitored again.

If the first real-time network data packet is less than the first threshold value for the preset number of consecutive times, it is determined that the load of the first communication link 111 is normal, and the second communication link 112 remains in the cut-off status. The first communication link 111 communicates alone, and monitoring the load of the first communication link 111 is stopped. After a stop of a period of time (for example, 30 minutes), the load of the first communication link 111 is monitored again.

If in the preset number of consecutive times, at least once the first real-time network data packet is less than the first threshold value, then it is necessary to continue to capture the first real-time network data packet and compare the first real-time network data packet with the first threshold value, until the first real-time network data packet is greater than or equal to or equal to the first threshold value for the preset number of consecutive times, or not to stop capturing the data packet of the first configuration information until the first real-time network data packet is less than the first threshold value for multiple consecutive data collection cycles.

In some embodiments, when the first communication link 111 and the second communication link 112 are used for communication together, Step S12 of controlling the communication status of the first communication device 110 includes Step S125 to Step 128.

In Step S125, the first configuration information of the first communication link 111 and second configuration information of the second communication link 112 are acquired. In an embodiment, the first configuration information includes the IP address and the communication port of the first communication link 111, and the second configuration information includes an IP address and a communication port of the second communication link 112.

In Step S126, the data packet including the first configuration information within the preset time period and a data packet including the second configuration information within a preset time period are captured, to obtain the first real-time network data packet and a second real-time network data packet. In an embodiment, the preset time period is a set time period, and the preset time period may be 2 s, 3 s, 5 s, or any other time period.

In Step S127, the sum of the first real-time network data packet and the second real-time network data packet is compared with the first threshold value.

In Step S128, when the sum of the first real-time network data packet and the second real-time network data packet is less than the first threshold value for the preset number of consecutive times, the second communication link 112 is controlled to be cut off communication, and the first communication device 110 is switched to be in communication with the access devices A1-An through the first communication link 111 alone. Specifically, communications through both the second communication link 112 and the first communication link 111 are switched to be communications through the first communication link 111 alone, and all the data collection points of the second communication link 112 are transferred to the first communication link 111.

When the sum of the first real-time network data packet and the second real-time network data packet is less than the first threshold value for the preset number of consecutive times, it is determined that the load is normal, and the second communication link 112 is controlled to be cut off, and the data collection points of the second communication link 112 are transferred to the first communication link 111, and the original data of the access devices A1-An are obtained through the first communication link 111. After cutting off the second communication link 112, the terminal stops monitoring the loads of the first communication link 111 and of the second communication link 112, and after a stop of a period of time (for example, 30 minutes), the load of the first communication link 111 is monitored and the first real-time network data packet is obtained again.

When at least once the sum of the first real-time network data packet and the second real-time network data packet is greater than or equal to the first threshold value, it is determined that there is an overload, and the capturing of the data packet of the first configuration information and the data packet of the second configuration information are stopped, and the status of communications through both the first communication link 111 and the second communication link 112 remains unchanged. After a stop of a period of time (for example, 30 minutes), the terminal monitors the sum load of the first communication link 111 and the second communication link 112 again.

In some embodiments, controlling the communication status of the first communication device 110 includes step S101.

In Step S101, the first communication device 110 is controlled to communicate through the first communication link 111 and the second communication link 112 during a set time period, and the set time period is a peak communication time period.

In this way, the workload of the first load balancing device 130 is reduced. The peak communication time period may be a time period obtained according to historical data communication.

In some embodiments, step S30 of sending the analyzed data stored to the client server or the third-party server according to the sending request or the configuration information, includes step S31 and step S32.

In Step S31, a third communication link and a fourth communication link establish is established between the second communication device 331 and a client server or a third-party server.

In Step S32, a working status of the second communication device 331 is controlled. When the communication flow of the second communication device 331 is less than a second threshold value, the access devices A1-An are controlled to communicate through the third communication link. When the communication flow of the second communication device 331 is greater than or equal to the second threshold value, the third communication link and the fourth communication link are controlled to be used for communication together.

In some embodiments, as shown in FIG. 11, Step S20 of storing the analyzed data includes the following steps S201 and S202.

In Step S201, the analyzed data is compared with the previous analyzed data obtained through analyzing last time, to determine whether the analyzed data have changed or not.

In Step S202, the analyzed data obtained by analyzing each time are written to the first storage area 210, and the analyzed data, which have changed compared with the previous analyzed data, are written to the second storage area 220.

Each time the original data of the access devices A1-An are obtained, and the original data are analyzed to obtain the analyzed data. The analyzed data are written to the first storage area 210, and simultaneously, the analyzed data are compared with the previous analyzed data of the access devices A1-An to determine whether the analyzed data of the access devices A1-An have changed or not. If the analyzed data of the access devices A1-An have changed, the analyzed data obtained by the analysis are written to the second storage area 220. If the analyzed data of the access device A have not changed, they are not written to the second storage area 220.

In some embodiments, writing the analyzed data, which have changed compared with the previous analyzed data, to the second storage area in Step S202 includes Steps S2021 and S2022.

In Step S2021, the analyzed data, whose working status data have changed compared with those of the previous analyzed data, are written to the changed-status-data storage area 221.

In Step S2022, the analyzed data, whose analogy data have changed compared with those of the previous analyzed data, are written to the changed-analog-data storage area 222.

The terminal compares the analyzed data of an access device An with the corresponding previous analyzed data. If the working status data of the analyzed data of the access device An have changed, the analyzed data are written to the changed-status-data storage area 221. If the analog data (the voltage, the power, or the current of the access device A1-An, etc.) of the analyzed data of the access device An have changed, the analyzed data are written to the changed-analog-data storage area 222. If both the working status data and the analog data of the analyzed data of the access device An have changed, the analyzed data are written to the changed-status-data storage area 221 and the changed-analog-data storage area 222 respectively. If neither the working status data nor the analog data have changed, the analyzed data are not written to the second storage area 220 in the current data collecting cycle.

For example, the analyzed data indicate that the working status of the access device An is “working”, and the previous analyzed data indicate that the working status of the access device An is “sleeping”, then the working status of the access device An has changed relatively. If the working status of the access device An is “working”, the changed working status data are written to the changed-status-data storage area 221. If the analyzed data obtained by a subsequent analyzing indicate that the working status of the access device An is “sleeping”, the changed subsequent working status data are written to the changed-status-data storage area 221, and the working status data previously stored in the changed-status-data storage area 221 are overwritten.

Similarly, if the analyzed data indicate that the current or power of the access device An has changed relative to the previous analyzed data, the analyzed data of the current or power of the access device An are written to the changed-analog-data storage area 222.

In some embodiments, the analyzed data are written to the first storage area 210 or the second storage area 220 by using a locking path, where the locking path is a path using a mutex lock, and the mutex lock is configured to realize a mutual exclusion of write operations.

An exemplary embodiment of the present disclosure also provides an energy management system. As shown in FIG. 1, the energy management system includes a data acquisition layer 100, a data storage layer 200, and a data management layer 300.

The data acquisition layer 100 is configured to obtain original data of an access device, analyze the original data, and obtain analyzed data. The access device is a device of an energy storage system. The data acquisition layer 100 is connected to multiple access devices A1-An of the energy storage system. For example, an access device An may be an electric meter, a transformer, a current transformer of the energy storage system, etc. The data acquisition layer 100 obtains original data of the multiple access devices A1-An, and the original data of the access devices A1-An include operation data, power data, test data, etc. For example, the original data obtained by the data acquisition layer 100 include parameters such as voltage, power, current, and working status of the access devices A1-An.

The data storage layer 200 is configured to store the analyzed data outputted by the data acquisition layer 100.

The data management layer 300 is configured to send the analyzed data stored in the data storage layer 200 to a client server or a third-party server according to a sending request or configuration information.

Referring to FIG. 2 and FIG. 4, the data storage layer 200 includes a data analyzing device 120, and the data analyzing device 120 includes: an analyzing unit 121, a second comparison unit 122, and a writing unit 123.

The analyzing unit 121 is configured to analyze the original data to obtain the analyzed data.

The second comparison unit 122 is configured to compare the analyzed data with the previous analyzed data obtained through analyzing last time, to determine whether the analyzed data have changed or not.

The writing unit 123 is configured to write the analyzed data to the data storage layer 200.

Referring to FIG. 5, the data storage layer 200 includes: a first storage area 210 and a second storage area 220.

The first storage area 210 is configured to store the data analyzed by the data acquisition layer 100 each time.

The second storage area 220 is configured to store the analyzed data which, compared with the previous analyzed data, have changed.

Each time the data acquisition layer 100 obtains the original data of the access devices A1-An, the data analysis device 120 analyzes the original data to obtain the analyzed data, writes the analyzed data to the first storage area 210, and simultaneously, compares the analyzed data with the previous analyzed data of the access devices A1-An to determine whether the analyzed data of the access devices A1-An have changed or not. If the analyzed data of the access devices A1-An have changed, the analyzed data obtained by the analysis are written to the second storage area 220.

In some embodiments, referring to FIG. 5, the second storage area 220 includes: a changed-status-data storage area 221 and a changed-analog-data storage area 222.

The changed-status-data storage area 221 is configured to store the analyzed data, whose working status data, compared with those of the previous analyzed data, have changed.

The changed-analog-data storage area 222 is configured to store the analyzed data, whose analog data, compared with those of the previous analyzed data, have changed.

The second comparison unit 122 compares the analyzed data of an access device An with the corresponding previous analyzed data. If the working status data of the analyzed data of the access device An have changed, the writing unit 123 writes the analyzed data to the changed-status-data storage area 221. If the analog data (the voltage, the power, or the current of the access device A1-An, etc.) of the analyzed data of the access device An have changed, the analyzed data are written to the changed-analog-data storage area 222. If both the working status data and the analog data of the analyzed data of the access device An have changed, the analyzed data are written to the changed-status-data storage area 221 and the changed-analog-data storage area 222 respectively. If neither the working status data nor the analog data have changed, the analyzed data are not written to the second storage area 220 in the current data collecting cycle.

For example, the analyzed data indicate that the working status of the access device An is “working”, and the previous analyzed data indicate that the working status of the access device An is “sleeping”, then the working status of the access device An has changed relatively. If the working status of the access device An is “working”, the changed working status data are written to the changed-status-data storage area 221. If the analyzed data obtained by a subsequent analyzing indicate that the working status of the access device An is “sleeping”, the changed subsequent working status data are written to the changed-status-data storage area 221, and the working status data previously stored in the changed-status-data storage area 221 are overwritten.

Similarly, if the analyzed data indicate that the current or power of the access device An has changed relative to the previous analyzed data, the analyzed data of the current or power of the access device An are written to the changed-analog-data storage area 222.

In some embodiments, each storage area includes a plurality of sub-storage areas corresponding to the respective access devices A1-An of the data acquisition layer 100.

The data acquisition layer 100 determines sub-storage areas corresponding to the access devices A1-An according to the data names and data values of the analyzed data, and writes the analyzed data to the sub-storage areas corresponding to the access devices A1-An.

For example, the first communication device 110 is connected to the device A1, the device A2, the device A3, . . . , and the device An for communication respectively, then each data storage area (each of the first storage area 210, the changed-status-data storage area 221, and the changed-analog-data storage area 222) is correspondingly provided with a sub-storage area M1, a sub-storage area M2, a sub-storage area M3, . . . , and a sub-storage area Mn.

The data acquisition layer 100 collects the original data of the access devices A1-An, and the communication configuration information of the access devices A1-An may be used as the identification of the original data, and the original data are named with the communication configuration information of the access devices A1-An. After the data acquisition layer 100 analyzes the original data and obtains the analyzed data, the analyzed data are written to the sub-storage area corresponding to the access devices A1-An in the first storage area 210 or in the second storage area 220 according to the data names and the data values of the analyzed data.

In some embodiments, referring to FIG. 6, each sub-storage area Mn of the first storage area 210 includes a plurality of data blocks 201-1 to 201-n arranged in a circular manner, and each sub-storage area Mn of the first storage area 210 is configured to sequentially store the analyzed data to the plurality of data blocks according to write times.

Each sub-storage area Mn of the first storage area 210 includes a plurality of data blocks 201-1 to 201-n arranged in a circular manner, and each data block is configured to store an analyzed data. A data block for storing firstly may be configured to be any one of the plurality of data blocks 201-1 to 201-n, and the analyzed data are written to the data blocks 201-1 to 201-n according to an order of the write times. If the data blocks 201-1 to 201-n in the sub-storage area are all full, then new analyzed data are written to the data blocks 201-1 to 201-n in the order of the writing times to overwrite the analyzed data stored in the data blocks, thus avoiding abnormal cases, such as the sub-storage area being full and a data overflow.

In an implementable embodiment, if the data blocks 201-1 to 201-n of a sub-storage area of the first storage area 210 are all full, and when new analyzed data are being written to a data block where an analyzed data is stored, the analyzed data stored in the data block may be deleted and then the new analyzed data is stored in the data block; or, the analyzed data stored in the data block may be replaced with the new analyzed data.

In some embodiments, each sub-storage area of the changed-analog-data storage area 222 includes a plurality of data blocks arranged in a circular manner, and each data block is configured to store a changed analog parameter.

For example, a sub-storage area of the changed-analog-data storage area 222 is configured to store the changed data of the analog parameters of the access device A1. The analog parameters of the access device A1 include a voltage, a power, and a current. The sub-storage area includes three data blocks, which are arranged in a circular manner. The three data blocks are configured to store the changed voltage parameter, the changed power parameter, and the changed current parameter of the access device A1 in sequence.

In some embodiments, multiple storage areas of the changed-status-data storage area 221 are arranged in a circular manner, and each sub-storage area is configured to store a changed status parameter of the access device An.

In some embodiments, the writing unit 123 writes the analyzed data to the data storage layer 200 by using a locking path, where the locking path is a path using a mutex lock, and the mutex lock is configured to realize a mutual exclusion of write operations.

An exemplary embodiment of the present disclosure provides an energy management method, which may be applied to an application environment of information collection of the access devices A1-An. The method may be applied to a terminal or a server, and may also be applied to a system including the terminal and the server and is implemented through an interaction between the terminal and the server. The terminal may be but is not limited to any one of personal computers, laptops, smart phones, tablet computers, etc.

In an embodiment, an energy management method is provided. As shown in FIG. 9, the energy management method is used in the energy management system above and includes the following steps S10 to S30.

In Step S10, original data of an access device are obtained, and analyzed to obtain the analyzed data. The access device is a device of the energy storage system.

In Step S20, the analyzed data are stored.

The access device is a device of an energy storage system. Multiple access devices A1-An of the energy storage system are connected. For example, an access device An may be an electric meter, a transformer, a current transformer of the energy storage system, etc. Original data of the multiple access devices A1-An are obtained, and the original data of the access devices A1-An include operation data, power data, test data, etc. For example, the obtained original data include parameters such as voltage, power, current, and working status of the access devices A1-An.

In Step S30, the analyzed data stored in the data storage layer 200 are sent to a client server or a third-party server according to a sending request or configuration information.

As shown in FIG. 11, in the method, Step S20 of storing the analyzed data includes the following steps S201 and S202.

In Step S201, the analyzed data is compared with the previous analyzed data obtained through analyzing last time, to determine whether the analyzed data have changed or not.

In Step S202, the analyzed data obtained by analyzing each time are written to the first storage area 210, and the analyzed data, which have changed compared with the previous analyzed data, are written to the second storage area 220.

Each time the original data of the access devices A1-An are obtained, and the original data are analyzed to obtain the analyzed data. The analyzed data are written to the first storage area 210, and simultaneously, the analyzed data are compared with the previous analyzed data of the access devices A1-An to determine whether the analyzed data of the access devices A1-An have changed or not. If the analyzed data of the access devices A1-An have changed, the analyzed data obtained by the analysis are written to the second storage area 220. If the analyzed data of the access device A have not changed, they are not written to the second storage area 220.

In some embodiments, writing the analyzed data, which have changed compared with the previous analyzed data, to the second storage area in Step S202 includes Steps S2021 and S2022.

In Step S2021, the analyzed data, whose working status data have changed compared with those of the previous analyzed data, are written to the changed-status-data storage area 221.

In Step S2022, the analyzed data, whose analogy data have changed compared with those of the previous analyzed data, are written to the changed-analog-data storage area 222.

The terminal compares the analyzed data of an access device An with the corresponding previous analyzed data. If the working status data of the analyzed data of the access device An have changed, the analyzed data are written to the changed-status-data storage area 221. If the analog data (the voltage, the power, or the current of the access device A1-An, etc.) of the analyzed data of the access device An have changed, the analyzed data are written to the changed-analog-data storage area 222. If both the working status data and the analog data of the analyzed data of the access device An have changed, the analyzed data are written to the changed-status-data storage area 221 and the changed-analog-data storage area 222 respectively. If neither the working status data nor the analog data have changed, the analyzed data are not written to the second storage area 220 in the current data collecting cycle.

For example, the analyzed data indicate that the working status of the access device An is “working”, and the previous analyzed data indicate that the working status of the access device An is “sleeping”, then the working status of the access device An has changed relatively. If the working status of the access device An is “working”, the changed working status data are written to the changed-status-data storage area 221. If the analyzed data obtained by a subsequent analyzing indicate that the working status of the access device An is “sleeping”, the changed subsequent working status data are written to the changed-status-data storage area 221, and the working status data previously stored in the changed-status-data storage area 221 are overwritten.

Similarly, if the analyzed data indicate that the current or power of the access device An has changed relative to the previous analyzed data, the analyzed data of the current or power of the access device An are written to the changed-analog-data storage area 222.

In some embodiments, the analyzed data are written to the first storage area 210 or the second storage area 220 by using a locking path, where the locking path is a path using a mutex lock, and the mutex lock is configured to realize a mutual exclusion of write operations.

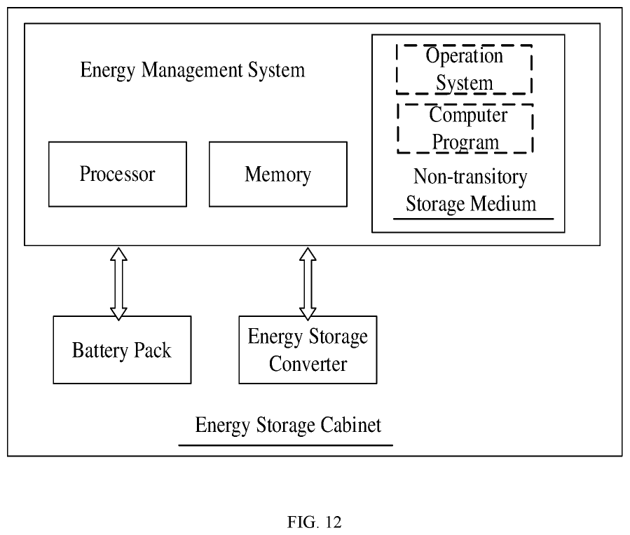

In an embodiment, an energy storage cabinet is provided. As shown in FIG. 12, the energy storage cabinet includes a battery pack, an energy storage converter, and an energy management system. The energy management system includes a memory and a processor, the memory stores a computer program, and the processor, when executing the computer program, implements the energy management methods of the embodiments above. The processor of the energy storage cabinet is configured to provide computing and control capabilities. The memory of the energy storage cabinet includes a non-volatile storage medium and an internal memory. The non-transitory storage medium stores an operating system and a computer program. The internal memory provides an environment for the operation of the operating system and the computer program in the non-transitory storage medium. The communication interface of the electronic device is configured to communicate with an external terminal in a wired or wireless manner, and the wireless manner may be implemented through WIFI, a mobile cellular network, NFC (near field communication) or other technologies. The processor, when executing the computer program, implements an energy management method. The memory stores a computer program, and the processor, when executing the computer program, implements the energy management methods of the above embodiments.

Those skilled in the art may understand that, the structure shown in FIG. 12, a block diagram, is only a structure of a part related to the solutions of the present application, and does not constitute a limitation on the energy storage cabinet to which the solutions of the present application are applied. A specific energy storage cabinet may include more or fewer components than those shown in the figure, or combine certain components, or have different component arrangements.

In an embodiment, an electronic device is provided, and the electronic device includes a memory and a processor, and a computer program is stored in the memory. The processor, when executing the computer program, implements the steps of the method described in any one of the above embodiments.

In an embodiment, a non-transitory computer-readable storage medium is provided, on which a computer program is stored, and the computer program, when executed by a processor, implements the steps of the method described in any one of the above embodiments.

In an embodiment, a computer program product is provided, and the computer program product includes a computer program. The computer program, when executed by a processor, implements the steps of the method described in any one of the above embodiments.

It should be noted that the user information (including but not limited to user device information, user personal information, etc.) and data (including but not limited to data for analysis, stored data, displayed data, etc.) involved in the present application are all information and data authorized by the user or fully authorized by all parties.

A person of ordinary skill in the art may understand that all or part of the processes in the methods of the above embodiments may be achieved by the relevant hardware instructed by the computer programs. The computer programs may be stored in a non-transitory computer readable storage medium, and when being executed, perform the processes such as those of the methods of the embodiments described above. The memory, database, or other medium recited in the embodiments of the disclosure include at least one of non-transitory and transitory memory. Non-transitory memory includes read-only memory (ROM), magnetic tape, floppy disk, flash memory, optical memory, high density embedded non-transitory memory, resistive random-access memory (ReRAM), magneto resistive random-access memory (MRAM), ferroelectric random-access memory (FRAM), phase change memory (PCM), or graphene memory, etc. Transitory memory includes random access memory (RAM) or external cache memory, etc. For illustration rather than limitation, RAM may be in various forms, such as static random-access memory (SRAM) or dynamic random-access memory (DRAM), etc. The databases involved in the embodiments of the present disclosure may include at least one of a relational database and a non-relational database. The non-relational databases may include, but are not limited to, a block chain-based distributed database, etc. The processors involved in the embodiments of the present disclosure may be but are not limited to general purpose processors, central processing units, graphics processors, digital signal processors, programmable logicians, quantum computing-based data processing logicians, etc.

The technical features of the foregoing embodiments may be arbitrarily combined. For brevity, not all possible combinations of the technical features in the foregoing embodiments are described. However, the combinations of these technical features should be considered to be included within the scope of the present disclosure, as long as the combinations are not contradictory.

The embodiments described above are several implementations of the present disclosure, and the description thereof is specific and detailed, but cannot be construed as a limitation to the scope of the present disclosure. It should be noted that for a person of ordinary skill in the art, various modifications and improvements may be made without departing from the concept of the present disclosure, and all these modifications and improvements are all within the protection scope of the present disclosure. Therefore, the protection scope of the present disclosure shall be subject to the attached claims.

What is claimed is:

1. An energy management system, comprising:
a data acquisition layer configured to obtain and analyze original data of one or more access devices to obtain analyzed data, each access device being a device of an energy storage system;
a data storage layer configured to store the analyzed data outputted by the data acquisition layer; and
a data management layer configured to send the analyzed data stored in the data storage layer to a client server or a third-party server according to a sending request or configuration information;
wherein, the data acquisition layer comprises:
a first communication device configured to establish a first communication link and a second communication link with each access device; and
a first load balancing device configured to control a communication status of the first communication device, so that each access device communicates with the first communication device through the first communication link in a case that a communication flow of the first communication device is less than a first threshold value, and so that each access device communicates with the first communication device through both the first communication link and the second communication link in a case that the communication flow of the first communication device is greater than or equal to the first threshold value.

2. The energy management system of claim 1, wherein:
the first load balancing device comprises an information acquisition unit, a packet capture unit, a first comparison unit, and a control unit; and
in a case that each access device communicates through the first communication link alone:
the information acquisition unit is configured to obtain first configuration information of the first communication link;
the packet capture unit is configured to capture a data packet comprising the first configuration information within a preset time period to obtain a first real-time network data packet;
the first comparison unit is configured to compare the first real-time network data packet with the first threshold value; and
the control unit is configured to, in a case that the first real-time network data packet is greater than or equal to the first threshold value for a preset number of consecutive times, control the second communication link to start, and control the first communication device to communicate through the first communication link and the second communication link.

3. The energy management system of claim 1, wherein:
the first load balancing device comprises an information acquisition unit, a packet capture unit, a first comparison unit, and a control unit; and
in a case that the first communication link and the second communication link are used for communication together:
the information acquisition unit is configured to acquire first configuration information of the first communication link and second configuration information of the second communication link;
the packet capture unit is configured to capture a data packet comprising the first configuration information within a preset time period, and a data packet comprising the second configuration information within the preset time period, to obtain a first real-time network data packet and a second real-time network data packet;
the first comparison unit is configured to compare a sum of the first real-time network data packet and the second real-time network data packet with the first threshold value; and
the control unit is configured to, in a case that the sum of the first real-time network data packet and the second real-time network data packet is less than the first threshold value for a preset number of consecutive times, control the second communication link to be cut off, and switch the first communication device to be in communication with each access device through the first communication link.

4. The energy management system of claim 1, wherein the first load balancing device is further configured to control the first communication device to communicate through the first communication link and the second communication link during a set time period, and the set time period is a peak communication time period.

5. The energy management system of claim 1, wherein:
the data management layer comprises a forwarding device;
the forwarding device comprises:
a second communication device configured to establish a third communication link and a fourth communication link with the client server or the third-party server; and
a second load balancing device configured to: control a working status of the second communication device; control each access device to communicate through the third communication link when a communication flow of the second communication device is less than a second threshold value; and control the third communication link and the fourth communication link to be used for communication together when the communication flow of the second communication device is greater than or equal to the second threshold value.

6. The energy management system of claim 1, wherein,
the data acquisition layer further comprises a data analyzing device, and the data analyzing device comprises:
an analyzing unit configured to analyze the original data to obtain the analyzed data;
a second comparison unit configured to compare the analyzed data with previous analyzed data obtained through analyzing last time to determine whether the analyzed data have changed or not; and
a writing unit configured to write the analyzed data to the data storage layer; and
the data storage layer comprises:
a first storage area configured to store the data analyzed by the data acquisition layer each time; and
a second storage area configured to store the analyzed data which, compared with the previous analyzed data, have changed.

7. The energy management system of claim 6, wherein the second storage area comprises:
a changed-status-data storage area configured to store the analyzed data, whose working status data, compared with those of the previous analyzed data, have changed; and
a changed-analog-data storage area configured to store the analyzed data, whose analog data, compared with those of the previous analyzed data, have changed.

8. The energy management system of claim 7, wherein:
each of the first storage area, the changed-status-data storage area, and the changed-analog-data storage area comprises multiple sub-storage areas respectively configured according to each access device connected to the data acquisition layer; and
the data acquisition layer determines each sub-storage area corresponding to each access device according to data names and data values of the analyzed data, and writes the analyzed data to each sub-storage area corresponding to each access device.

9. The energy management system of claim 8, wherein each sub-storage area of the first storage area comprises a plurality of data blocks arranged in a circular manner, and each sub-storage area of the first storage area, which is one-to-one correspondence with each access device, is configured to sequentially store analyzed data of a corresponding access device to the plurality of data blocks thereof according to write times.

10. The energy management system of claim 8, wherein each sub-storage area of the changed-analog-data storage area comprises a plurality of data blocks arranged in a circular manner, and each data block is configured to store a changed analog data.

11. The energy management system of claim 6, wherein the writing unit is configured to write the analyzed data to the data storage layer by using a locking path; the locking path is a path using a mutex lock; and the mutex lock is configured to realize a mutual exclusion of write operations.

12. An energy management method, applied to the energy management system of claim 1, comprising:
obtaining and analyzing the original data of one or more access devices to obtain the analyzed data, each access device being the device of the energy storage system;
storing the analyzed data; and
sending stored analyzed data to the client server or the third-party server according to the sending request or the configuration information;
wherein, obtaining and analyzing the original data of one or more access devices to obtain the analyzed data comprises:
establishing the first communication link and the second communication link between the first communication device and each access device; and
controlling the communication status of the first communication device, so that each access device communicates with the first communication device through the first communication link in a case that the communication flow of the first communication device is less than the first threshold value, and so that each access device communicates with the first communication device through both in the case that the communication flow of the first communication device is greater than or equal to the first threshold value.

13. The energy management method of claim 12, wherein in a case that each access device communicates through the first communication link alone, controlling the communication status of the first communication device comprises:
obtaining first configuration information of the first communication link;
capturing a data packet comprising the first configuration information within a preset time period to obtain a first real-time network data packet;
comparing the first real-time network data packet with the first threshold value; and
in a case that the first real-time network data packet is greater than or equal to the first threshold value for a preset number of consecutive times, controlling the second communication link to start, and controlling the first communication link and the second communication link to be used for communication together.

14. The energy management method of claim 13, wherein in a case that the first communication link and the second communication link are used for communication together, controlling the communication status of the first communication device comprises:
acquiring first configuration information of the first communication link and second configuration information of the second communication link;
capturing a data packet comprising the first configuration information within a preset time period, and a data packet comprising the second configuration information within the preset time period, to obtain a first real-time network data packet and a second real-time network data packet;
comparing a sum of the first real-time network data packet and the second real-time network data packet with the first threshold value; and
in a case that the sum of the first real-time network data packet and the second real-time network data packet is less than the first threshold value for a preset number of consecutive times, controlling the second communication link to be cut off communication, and switching the first communication device to be in communication with each access device through the first communication link alone.

15. The energy management method of claim 12, wherein controlling the communication status of the first communication device comprises controlling the first communication device to communicate through the first communication link and the second communication link during a set time period, wherein the set time period is a peak communication time period.

16. The energy management method of claim 12, wherein sending the stored analyzed data to the client server or the third-party server according to the sending request or the configuration information comprises:
establish a third communication link and a fourth communication link between a second communication device and the client server or the third-party server; and
controlling a working status of the second communication device; controlling each access device to communicate through the third communication link when a communication flow of the second communication device is less than a second threshold value; and controlling the third communication link and the fourth communication link to be used for communication together when the communication flow of the second communication device is greater than or equal to the second threshold value.

17. The energy management method of claim 12, wherein storing the analyzed data comprises:
comparing the analyzed data with previous analyzed data obtained through analyzing last time to determine whether the analyzed data have changed or not; and
writing the analyzed data obtained each time to a first storage area; and writing the analyzed data which, compared with the previous analyzed data, have changed, to a second storage area.

18. The energy management method of claim 17, wherein the second storage area comprises a changed-status-data storage area and a changed-analog-data storage area; writing the analyzed data which, compared with the previous analyzed data, have changed, to the second storage area, comprises:
writing the analyzed data whose working status data, compared with working status data of the previous analyzed data, have changed, to the changed-status-data storage area; and
writing the analyzed data whose analog data, compared with analog data of the previous analyzed data, have changed, to the changed-analog-data storage area.

19. The energy management method of claim 17, wherein writing the analyzed data to the first storage area or to the second storage area is performed by using a locking path; the locking path is a path using a mutex lock; and the mutex lock is configured to realize a mutual exclusion of write operations.

20. The energy management method of claim 13, wherein the preset time period is 2 s, 3 s, or 5 s.
